(19) United States
(12) Patent Application Publication
(10) Pub. No.: US 2016/0031646 A1
(43) Pub. Date: Feb. 4, 2016

(54) TOOL FOR MANUALLY HANDLING HEAVY PLATES

(71) Applicant: HIGH STRENGTH PLATES & PROFILES INC., Mississauga (CA)

(72) Inventors: Jason Brock, Toronto (CA); Frank Cordeiro, Mississauga (CA)

(21) Appl. No.: 14/448,638

(22) Filed: Jul. 31, 2014

(51) Int. Cl. B65G 7/00; B25J 1/04

(52) U.S. Cl. CPC B65G 7/00; B25J 1/04

(57) ABSTRACT

A hand-operated tool is disclosed for handling a heavy plate while standing at a distance from the plate. The tool comprises a body with gripping members defining a notch for insertion of a plate. The gripping members have inner edges with stepped profiles, defining pairs of opposed gripping surfaces. The pairs of gripping surfaces are spaced apart at different widths for receiving plates of different thicknesses, a pairs close to the opening of the notch having a width greater than a pair farther from the opening of the notch. An elongate handle extends from the body, and a force may be applied to the handle to cause the opposed gripping surfaces frictionally and releasably retain the plate in the notch.

### FIELD

The present invention relates to material handling tools, and in particular, to tools for gripping and manually handling heavy plates.

### BACKGROUND

In many industrial settings, it is necessary to handle or manipulate large, heavy objects. For example, sheet or plate metal and the like may need to be moved from a shop or warehouse floor onto a vehicle, or vice-versa. Machinery may be used to assist, but in some cases, manual labour may be used to handle objects, in addition to, or instead of machinery. For example, a crane may be used to lift a plate and support its weight, while workers push and pull the plate by hand to achieve a precise desired position.

Unfortunately, such manual handling requires workers to stand adjacent to the plate, which may be dangerous to workers. For example, a plate may fall and injure workers.

Accordingly, there is a need for improved tools for handling plates.

### SUMMARY

In an aspect, a hand-held tool for handling heavy plates is disclosed, comprising: a body having first and second fixed gripping members opposed to define a notch in the body for insertion of a plate, the notch having opposed inner edges, each comprising at least two distinct gripping surfaces spaced along the length thereof, wherein a first pair of opposed ones of the gripping surfaces are spaced to receive a plate of a first maximum thickness and a second pair of opposed ones of said gripping surfaces are spaced to receive a plate of a second maximum thickness, the second maximum thickness greater than the first maximum thickness and the second pair of gripping surfaces located nearer to an opening of the notch than the first pair of gripping surfaces. The tool further comprises an elongate handle extending from the body. Each of the pairs of opposed gripping surfaces operable to frictionally and releasably retain a plate in the notch, by applying a force to the handle perpendicular to a top or bottom surface of the plate.

In another aspect, a hand-operated tool for handling a heavy plate is disclosed, comprising: a body having first and second opposed gripping members having inner edges defining a notch for insertion of a plate, the inner edges having stepped profiles, defining a first pair of opposed gripping surfaces and a second pair of opposed gripping surfaces located between the first pair and an opening of the notch, the notch having a first width between the first pair of opposed gripping surfaces to receive a plate of a first maximum thickness, and a second width, greater than the first width, between the second pair of opposed gripping surfaces to receive a plate of a second maximum thickness, greater than the first maximum thickness. The tool further comprises an elongate handle extending from the body. Each of the pairs of opposed gripping surfaces operable to frictionally and releasably retain a plate in said notch, by applying a force to the handle perpendicular to a top or bottom surface of the plate.

### BRIEF DESCRIPTION OF THE DRAWINGS

In the figures, which illustrate by way of example only, embodiments of this invention:

FIG. 1 is a perspective view of a suspended plate and tool for handling the plate;

FIG. 2 is a perspective view of the tool of FIG. 1;

FIG. 3 is a side elevation view of the tool of FIG. 1;

FIG. 4 is a bottom elevation view of the tool of FIG. 1;

FIG. 5 is an end elevation view of the tool of FIG. 1 from a first end;

FIG. 6 is an end elevation view of the tool of FIG. 1 from a second end;

FIG. 7 is an enlarged view of the portion of the tool of FIG. 3 indicated by the circle VII;

FIG. 8 is a schematic view of the tool of FIG. 1 receiving a plate;

FIG. 9 is a schematic view of the tool of FIG. 1 gripping a plate;

FIG. 10 is a perspective view of another tool;

FIG. 11 is a side elevation view of the tool of FIG. 10;

FIG. 12 is a bottom elevation view of the tool of FIG. 10;

FIG. 13 is an end elevation view of the tool of FIG. 10 from a first end;

FIG. 14 is an end elevation view of the tool of FIG. 10 from a second end;

FIG. 15 is a perspective view of another tool;

FIG. 16 is a side elevation view of the tool of FIG. 15;

FIG. 17 is a bottom elevation view of the tool of FIG. 15;

FIG. 18 is an end elevation view of the tool of FIG. 15 from a first end; and

FIG. 19 is an end elevation view of the tool of FIG. 15 from a second end.

### DETAILED DESCRIPTION

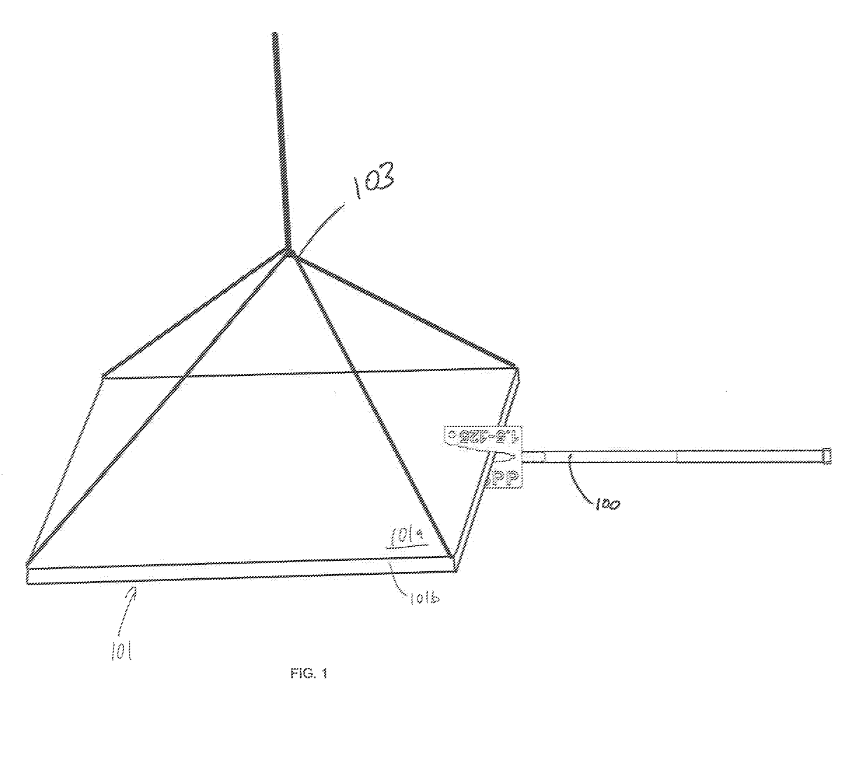

FIG. 1 depicts a hand operated handling tool 100 for manipulating a metal plate 101. In brief overview, using handling tool 100, a worker may be able to manually push and pull plate 101 without standing adjacent to, or underneath, the plate.

Plate 101 has top and bottom surfaces 101a and lateral surfaces 101b. As used herein, the “top surface” and “bottom surface” of a plate are the pair of opposing surfaces with the largest area. The lateral surfaces are the remaining pairs of surfaces with area smaller than that of the top and bottom surfaces. References to the thickness of a plate refer to the dimension of the lateral surfaces measured perpendicular to the top and bottom surfaces. The naming of plate surfaces as top, bottom or lateral need not correspond to the direction of gravity.

Plate 101 is depicted smaller than its actual length and width, each of which may be several feet or more. Plate 101 may be formed of fairly dense material, such as steel. Accordingly, plate 101 may weigh at hundreds or thousands of kilograms. As depicted, plate 101 is suspended by a crane 103, which supports the weight of plate 101. While plate 101 is suspended, a worker may manually manipulate tool 100 to move plate 101 to a desired position.

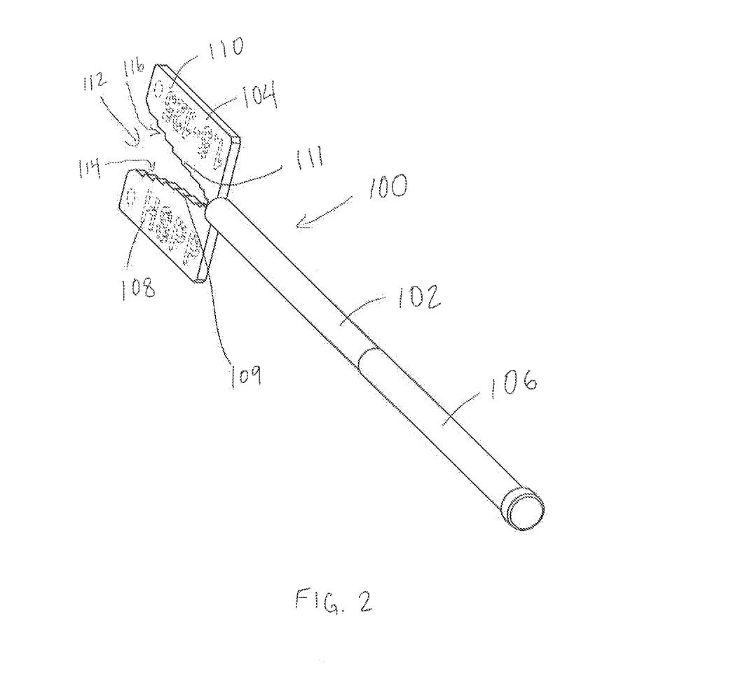

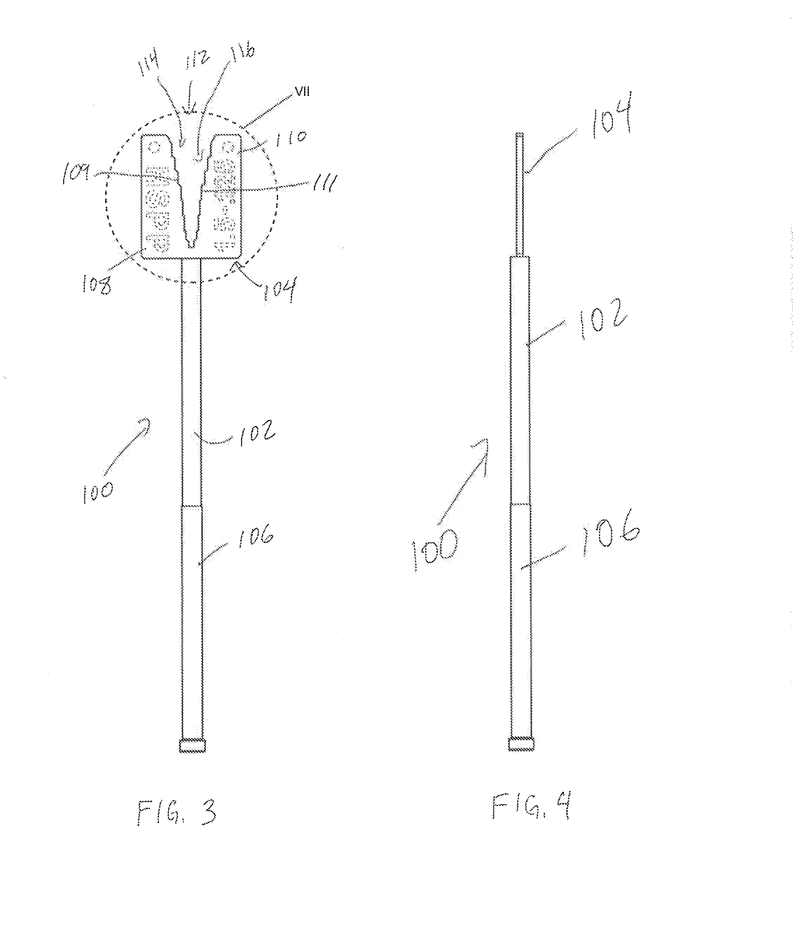

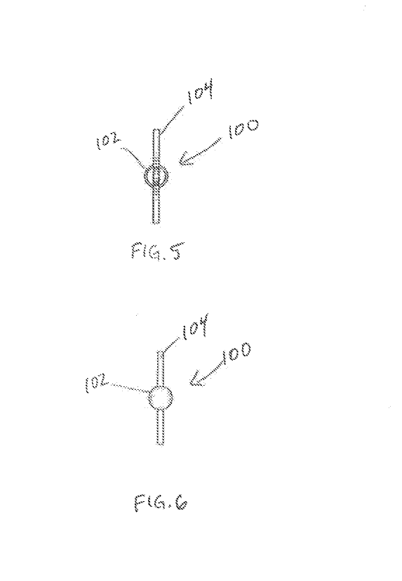

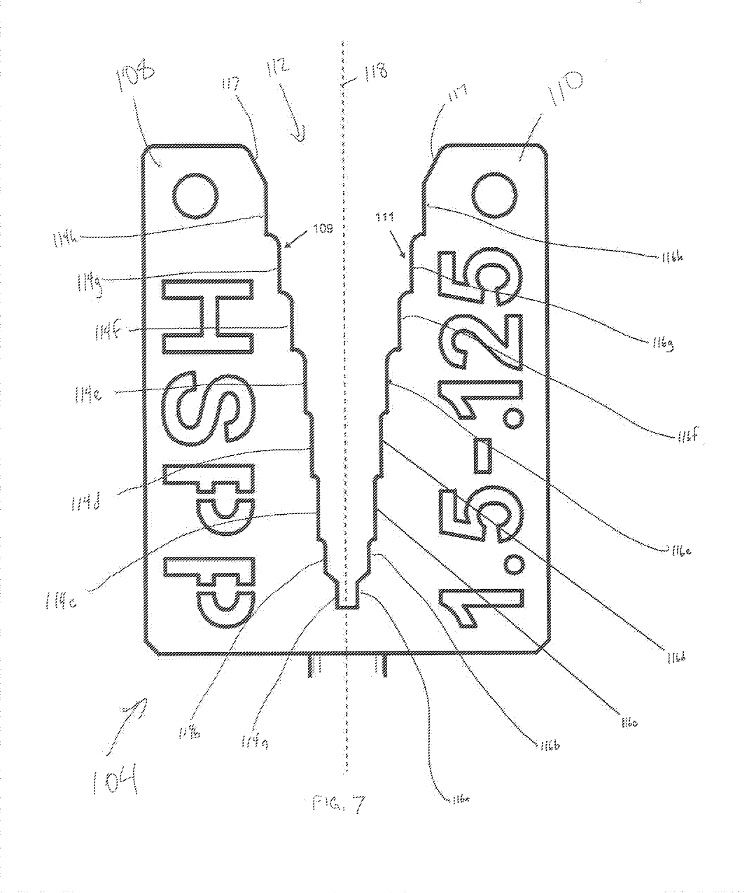

FIGS. 2-7 depict tool 100 in greater detail. FIG. 2 depicts tool 100 in perspective view. FIG. 3 depicts a first side view of tool 100. The opposite side view of tool 100 is a mirror image of FIG. 3. FIG. 4 depicts the bottom view of tool 100. The top view of tool 100 is identical to FIG. 4. FIG. 5 depicts a first end view of tool 100, and FIG. 6 depicts the second end view of tool 100.

Tool 100 has a rigid, elongated handle 102 and a rigid body 104. Body 104 is configured to be operable to releasably retain plate 101, so that a user may guide the plate by grasping handle 102.

Tool 100 is constructed of a suitably strong and lightweight material which provides sufficient strength and hardness to avoid failure during use to move plate 101 as described below, and which is sufficiently lightweight so that tool 100 may be safely used by hand by a worker. For example, tool 100 may be constructed of steel, such as mild steel, or aluminum. Other suitable materials will be readily apparent to skilled persons.

As shown in FIG. 2, handle 102 is a generally cylindrical bar. Handle 102 is sized to be grasped by hand of a worker and is sufficiently long so that a worker can manipulate a plate 101 while standing at a distance from the plate. In an example embodiment, the length of handle 102 may be between about 20 inches and 44 inches, and the outer diameter of handle 102 may be about 0.75 inches. However, handle 102 may be as long as necessary to allow a worker to stand a desired safe distance from the object being handled, provided that tool 100 is not too heavy to be safely used by workers. Further, the outer diameter of handle 102 may be larger or smaller to suit different hand sizes.

Handle 102 may be solid or hollow, with variable wall thickness, and may be constructed of metal, wood, plastic, or any other suitable material. The material and dimensions of handle 102 may be determined based on the required strength, as well as ergonomic considerations. For example, handle 102 may be constructed out of hollow steel tube, with wall thickness chosen based on the size and weight of plates to be handled, the desired length of handle 102, and the weight which can be safely handled by a worker.

Optionally, a cover 106 may be provided at the end of handle 102 opposite body 104. Cover 106 may, for example, be formed of a soft, tacky material such as foam rubber in order to provide a surface which can be comfortably and securely gripped.

Tool 100 has a longitudinal axis 118 which extends through the center of handle 102. As used herein, the terms “proximal” and “distal” refer to locations along longitudinal axis 118 relative to the position of a user. Body 104 is located at the distal end of handle 102 and cover 106 is located at the proximal end of handle 102, where tool 100 would be gripped by a user.

As depicted, handle 102 may be welded to body 104. However, in other embodiments, handle 102 and body 104 may be attached using fasteners such as bolts, or may be integrally formed with body 104.

Body 104 has a pair of fixed gripping members 108, 110 which extend distally, i.e., away from handle 102. Gripping members 108, 110 define a notch 112 configured to receive a plate—such as plate 101. Notch 112 has inner edges 109, 111 along gripping members 108, 110, respectively. Notch 112 is tapered and generally increases in width in the distal direction.

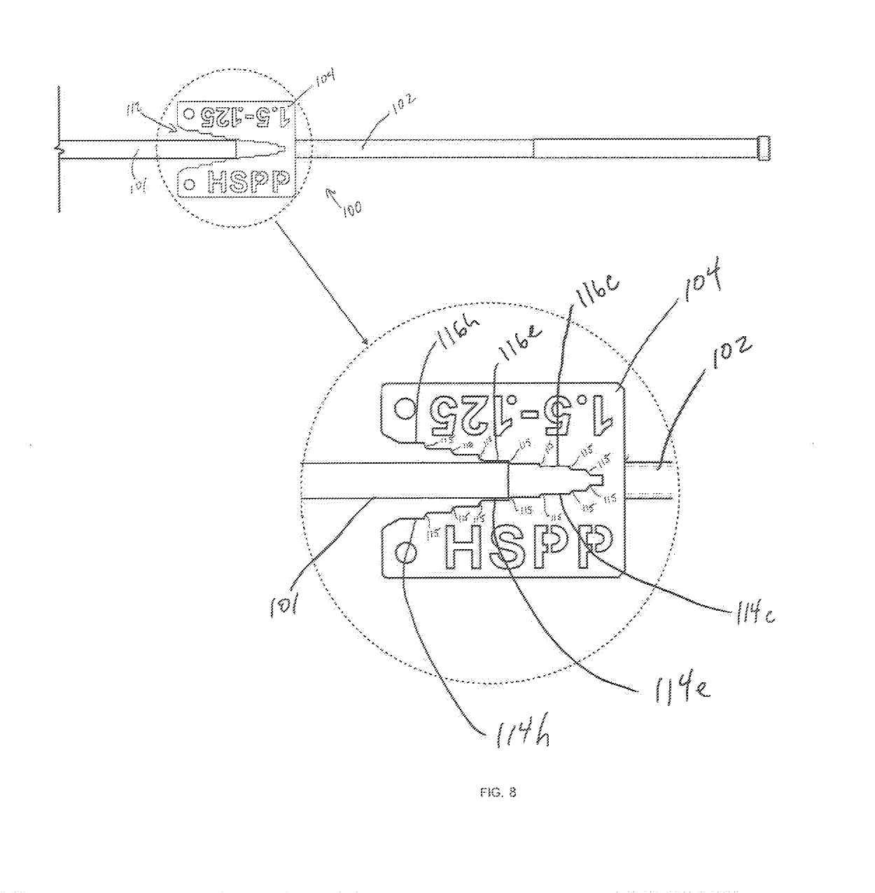

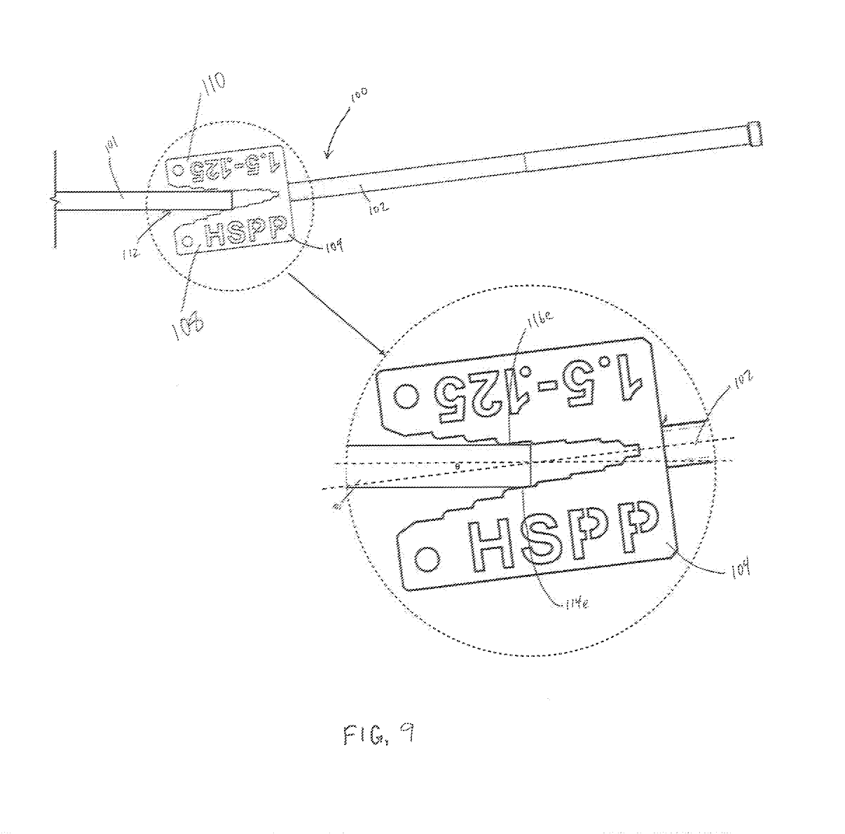

Inner edge 109 has one or more gripping surfaces 114. As depicted, gripping member 108 has eight gripping surfaces 114a-114h (FIG. 7; collectively, gripping surfaces 114). However, in other embodiments, more or fewer gripping surfaces 114 may be present.

Inner edge 111 has one or more gripping surfaces 116. As depicted, gripping member 110 has eight gripping surfaces 116a-116h (FIG. 7; collectively, gripping surfaces 116). However, in other embodiments, more or fewer gripping surfaces 116 may be present.

Each one of gripping surfaces 114 opposes a corresponding gripping surface 116. Thus, gripping surface 114a opposes gripping surface 116a; gripping surface 114b opposes gripping surface 116b and the like. Together, each pair of opposed gripping surfaces 114, 116 are spaced to receive a plate of up to a maximum thickness. Inner edges 109, 111 of gripping members 108, 110 have stepped profiles. Each pair of opposed gripping surfaces is spaced apart at a different width and therefore, the maximum thickness for each pair differs.

Gripping members 108 and 110 are symmetrical about a notch axis. As depicted, the notch axis is longitudinal axis 118. However, in other embodiments, notch axis may be different than (e.g. offset from or angled to) longitudinal axis 118.

Gripping surfaces 114, 116 are staggered. That is, each successive gripping surface 114 in the distal direction (i.e. in decreasing order of distance from the opening of notch 112) is located a greater distance from the notch axis. For example, gripping surface 114c is spaced farther from the notch axis than gripping surface 114b, which is in turn spaced farther from the notch axis than gripping surface 114a. Likewise, each successive gripping surface 116 in the distal direction is located a greater distance from notch axis.

As a result, the width of notch 112 progressively increases and notch 112 has eight different widths, measured between pairs of opposed gripping surfaces. The pairs increase from a minimum width between gripping surfaces 114a-116a to a maximum width between gripping surfaces 114h-116h. Each pair is symmetrical about the notch axis.

The width of each successive pair may increase by a consistent width increment. Alternatively, the widths may be selected to match a set of standard plate gauges or thicknesses, plus a desired clearance. In one embodiment, each pair may be sized to be 1/16 inch wider than a given nominal plate thickness, i.e. to provide 1/16 inch of clearance. For example, pairs 114a-116a, 114b-116b, 114c-116c, 114d-116d, 114e-116e, 114f, 116f and 114g-116g may be % inch, 7/16 inch, 9/16 inch, 11/16 inch, 13/16 inch, 1 1/16 inches, 1 5/16 inches and 1 9/16 inches, respectively, for gripping plates 3/16 inch, ⅜ inch, ½ inch, ⅝ inch, ¾ inch, 1 inch, 1¼% inches and ½ inches thick, respectively. Each gripping surface 114, 116 may be approximately ½ inch long, measured in the direction of the nozzle axis. As will be described hereinafter, other configurations are possible.

Between adjacent gripping surfaces 114 or 116, gripping members 108, 110 define detents 115. Detents 115 may abut plate 101 when received in notch 112 and thereby limit the distance plate 101 may be received into notch 112. Detents 115 span the width increment between adjacent pairs of opposed gripping surfaces 114, 116. As depicted, detents 115 are symmetrical, such that each individual detent spans half of the width increment.

Gripping surfaces 114, 116 are parallel to one another and to the notch axis. Thus, plate 101 can be received in notch 112 between a pair of opposed gripping surfaces 114, 116 having a width slightly greater than the thickness of plate 101, with the gripping surfaces of that pair generally parallel to and spaced slightly apart from surfaces of plate 101. Detents 115 are positioned at an angle to gripping surfaces 114, 116 to abut the end of a received plate 101 and thereby limit the travel of the plate into notch 112. As will be explained in further detail below, plates of different thicknesses may be received between different pairs of gripping surfaces 114, 116.

Gripping surfaces 114, 116 are configured to frictionally grip plate 101, and to allow a user to selectively grip and release plate 101, to manipulate plate 101. Optionally, gripping surfaces 114, 116 may be treated to increase the coefficient of friction between gripping surfaces 114, 116 and plate 101. For example, gripping surfaces 114, 116 may have grooves or teeth (not shown) for biting into plate 101. Alternatively, gripping surfaces 114, 116 may be roughened.

Notch 112 may have bevelled surfaces 117 positioned distally of gripping surfaces 114, 116. Bevelled surfaces 117 may ease alignment of a plate 101 with the notch axis and thus with notch 112. This may ease engagement of tool 100 to the plate 101.

Optionally, body 104 may have one or more cutouts 119, depicted in broken lines in FIGS. 2-6. Cutouts 119 reduce weight of body 104 and may be formed as indicia. For example, cutouts 119 may be formed to identify a range of plate thicknesses with which tool 100 is intended to be used, or an owner of tool 100.

In use, tool 100 may be positioned with notch 112 adjacent plate 101 and oriented so that plate 101 is generally aligned with the notch axis. This likewise aligns plate 101 with gripping surfaces 114, 116. Plate 101 may then be seated in notch 112 by pushing tool 100 against plate 101, so that plate 101 is received between a pair of opposed gripping surfaces 114, 116 with width slightly larger than the thickness of plate 101. Plate 101 abuts detents 115 positioned adjacent to that pair of gripping surfaces on the proximal side. Detents 115 thus limit the distance plate 101 may be received into notch 112.

As depicted in FIG. 4, plate 101 is received in notch 112 between gripping surfaces 114e, 116e and abuts detents 115 positioned between gripping surfaces 114e, 116e and 114d, 116d. Gripping surfaces 114e, 116e are parallel to and positioned slightly below and above plate 101, respectively.

Tool 100 can be used to grip plates with a range of thicknesses. As will be apparent, plates of different thicknesses will be received between different pairs of gripping surfaces 114, 116. Specifically, plates thinner than plate 101 may be received by a pair of gripping surfaces spaced closer together, i.e. a pair positioned farther from the opening of notch 112. For example, a plate thinner than plate 101 may fit between gripping surfaces 114c, 116c and abut detents 115 between gripping surfaces 114c, 116c and 114b, 116b. Conversely, plates thinner than plate 101 may be received by a pair of gripping surfaces spaced farther apart, i.e. a pair positioned closer to the opening of notch 112. For example, a plate thicker than plate 101 may fit between gripping surfaces 114h, 116h and abut detents 115 between gripping surfaces 114h, 116h and 114g. 116g.

Since each pair of opposed gripping surfaces is symmetrical about the notch axis, a plate received between any of the pairs will be generally aligned with the notch axis (as depicted, longitudinal axis 118 and handle 102). Alignment of handle 102 and plate 101 may contribute to relatively easy handling of plates. Conversely, moving plate 101 may be more difficult if tool 100 is angled upwardly or downwardly from plate 101 at a significant angle, as force on tool 100 will partly work upwardly, against the weight of plate 101, or downwardly, against the device supporting plate 101.

Once plate 101 is received in notch 112, tool 100 can be used to grip plate 101 by applying a force perpendicular to plate 101, i.e. by raising or lowering handle 102. Such a force will tend to torque tool 100 to rotate around plate 101. FIG. 7 depicts tool 100 gripping plate 101 with handle 102 in a raised position. As will be apparent, the force applied to tool 100 need not be precisely perpendicular to plate 101. Rather, any force with a component perpendicular to plate 101 (and thus, to axis 118) will tend to torque tool 100 in this manner.

Since plate 101 is very large and heavy, when a perpendicular force is applied to handle 102, plate 101 remains stationary or nearly stationary and tool 100 tends to pivot around plate 101.

Specifically, when handle 102 is raised (torqued upwardly), at least part of gripping member 110 is urged downwardly against plate 101 and at least part of gripping member 108 is urged upwardly against plate 101. A gripping surface on each gripping member comes into contact with plate 101, effectively pinching plate 101 between a gripping surface 116 and an opposed gripping surface 114. The applied force may also tend to urge the gripping surfaces 114, 116 to slide slightly against plate 101, engaging plate 101 frictionally. Torquing handle 102 to engage plate 101 may cause tool 100 to rotate relative to plate 101, creating an angular displacement θ. With plate 101 fully seated in notch 112, plate 101 may be gripped with only a small angular displacement. For example, in some embodiments, when plate 101 is fully seated in notch 112, an angular displacement of 20 degrees or less may be sufficient to grip plate 110. As noted, above, handling of plate 101 may be easier when the angular displacement between tool 100 and plate 101 is relatively small.

Pinching and frictional engagement by gripping surfaces 114, 116 may retain plate 101 in notch 112. Accordingly, while handle 102 is raised, tool 100 may grip plate 101 such that tool 100 can be used to push or pull plate 101. Thus, using tool 100, a worker may be able to manipulate plate 101 in much the same way as if directly by hand. However, the worker may be able to stand away from plate 101 at a distance approximately equal to the length of handle 102.

Engagement of plate 101 by tool 100 is releasable. Tool 100 may be disengaged from plate 101 by releasing or reversing the torque applied to handle 102. That is, if handle 102 is urged upwardly to engage plate 101, the plate may be disengaged by urging handle 102 downwardly. Accordingly, a worker gripping plate 101 with tool 100 can quickly release tool 100 from plate 101 in the event of an emergency, such as if plate 101 begins to fall. Alternatively, the worker can simply let go of handle 102.

Tool 100 may thus reduce hazards to workers, as compared to handling plates directly by hand. Standing at a distance from a suspended plate may reduce the risk of the plate falling on the worker, and in the event of an emergency, the worker may be able to quickly escape by releasing tool 100 from the plate or dropping handle 102.

In some embodiments, gripping surfaces 114, 116 may be formed of a material that is softer than that of plate 101. In such embodiments, when gripping surfaces 114, 116 are urged against plate 101, gripping surfaces may tend to scratch or deform rather than plate 101. Such scratching or deformation may strengthen the grip of tool 100 on plate 101.

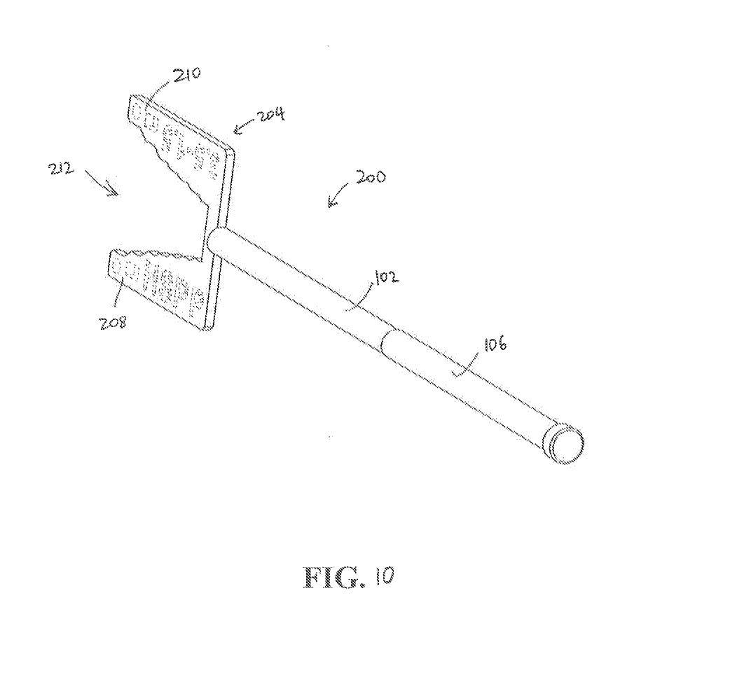

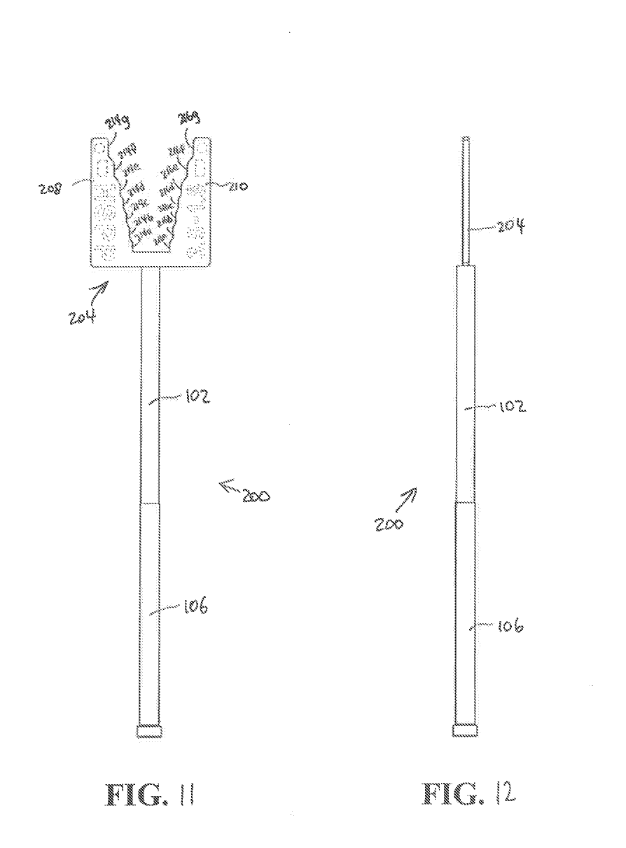

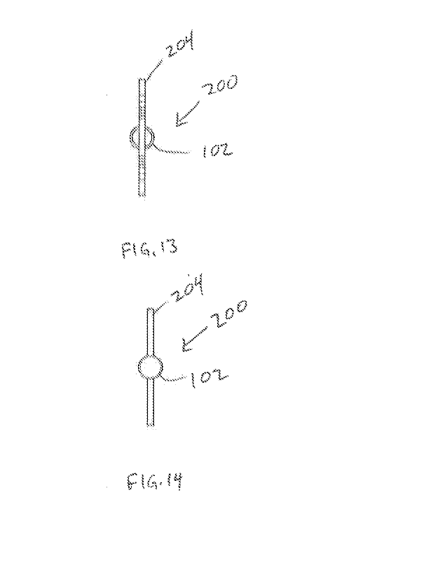

As noted above, the depicted tool 100 is configured for manipulating a plate 101 up to 1½ inches thick. However, other configurations are possible. For example, FIGS. 10-14 depict a tool 200 configured for manipulating a plate between 1½ inches and 3½ inches thick. FIG. 10 depicts tool 200 in perspective view. FIG. 11 depicts a first side view of tool 200. The opposite side view of tool 200 is a mirror image of FIG. 11. FIG. 12 depicts the bottom view of tool 200. The top view of tool 200 is identical to FIG. 12. FIG. 13 depicts a first end view of tool 200, and FIG. 14 depicts the opposite end view of tool 200. Many components of tool 200 are identical to those of tool 100 and are identified with like numerals.

Tool 200 has a body 204 with gripping members 208, 210 having seven opposed pairs of gripping surfaces 214a-214g and 216a-216g, defining a notch 212. Notch 212 has a width of 3.56 inch between gripping surfaces 214g, 216g and a width of 1 9/16 between gripping surfaces 214a, 216a. Each successive opposed pair of gripping surfaces differs in width from the adjacent pairs by approximately ⅓ inch.

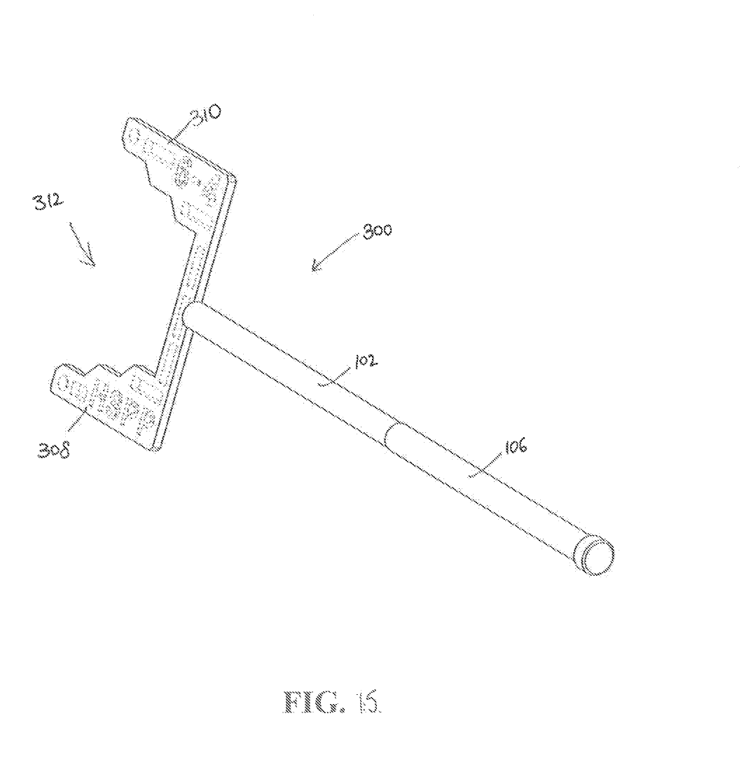

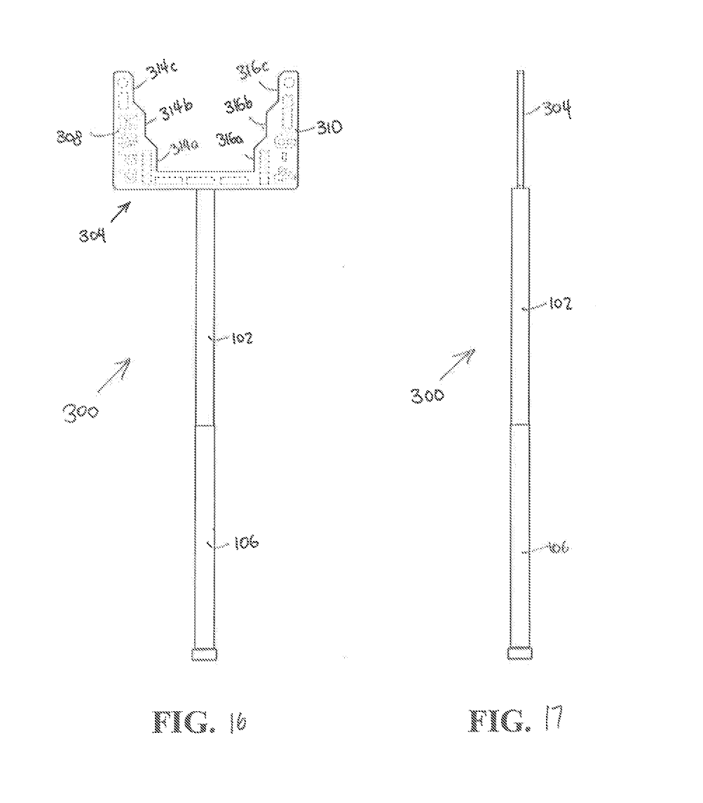

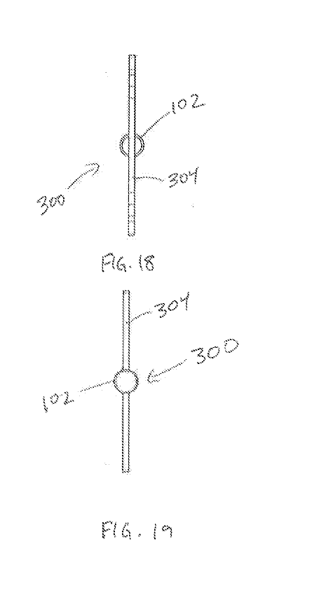

FIGS. 15-19 depict a tool 300 configured for manipulating a plate between 4 inches and 6 inches thick. FIG. 15 depicts tool 300 in perspective view. FIG. 16 depicts a first side view of tool 300. The opposite side view of tool 300 is a mirror image of FIG. 16. FIG. 17 depicts the bottom view of tool 300. The top view of tool 300 is identical to FIG. 17. FIG. 18 depicts a first end view of tool 300, and FIG. 19 depicts the opposite end view of tool 300. Many components of tool 300 are generally the same as those of tool 100 and are identified with like numerals.

Tool 300 has a body 304 with gripping members 308, 310 having three opposed pairs of gripping surfaces 314a-314c and 316a-316c, defining a notch 312. Notch 312 has a width of 6 1/16 inches between gripping surfaces 314c, 316c and a width of 4 1/16 inches between gripping surfaces 314a, 316a. Each successive opposed pair of gripping surfaces differs in width from the adjacent pairs by approximately 1 inch.

It is contemplated that an organization that routinely deals with plates of various sizes may have a series of tools of different sizes, like tools 100, 200, 300, suitable for use with most or all of the plate sizes commonly stocked by the organization.

Of course, the foregoing embodiments are intended to be illustrative only and in no way limiting. The described embodiments of carrying out the invention are susceptible to many modifications of form, arrangement of parts, details and order of operation. The invention, therefore, is intended to encompass all such modification within its scope, as defined by the claims

What is claimed:

1. A hand-held tool for handling heavy plates, comprising:
a body having first and second fixed gripping members opposed to define a notch in said body for insertion of a plate;
said notch having opposed inner edges, each comprising at least two distinct gripping surfaces spaced along the length thereof;
wherein a first pair of opposed ones of said gripping surfaces are spaced to receive a plate of a first maximum thickness and a second pair of opposed ones of said gripping surfaces are spaced to receive a plate of a second maximum thickness, said second maximum thickness greater than said first maximum thickness and said second pair of gripping surfaces located nearer to an opening of said notch than said first pair of gripping surfaces;
an elongate handle extending from said body;
each of said pairs of opposed gripping surfaces operable to frictionally and releasably retain a plate in said notch, by applying a force to said handle perpendicular to a top or bottom surface of said plate.

2. The tool of claim 1, wherein said notch extends along a notch axis and said gripping surfaces are configured symmetrically about said notch axis.

3. The tool of claim 2, wherein said gripping surfaces are staggered along the length of said notch, such that for each successive gripping surface in decreasing order of distance from said opening of said notch, the distance from said notch axis increases by a predetermined increment.

4. The tool of claim 3, wherein each of said inner edges comprises eight distinct gripping surfaces, wherein said predetermined increment is 1/32 inch and wherein the smallest distance between opposed ones of said gripping surfaces is ¼ inch and the largest distance between opposed ones of said gripping surfaces is 1 9/16 inches.

5. The tool of claim 1, wherein said elongate handle is between about 20 inches and 44 inches in length.

6. The tool of claim 2, wherein said gripping surfaces are oriented parallel to said notch axis.

7. The tool of claim 2, wherein said handle is aligned with said notch axis.

8. The tool of claim 1, further comprising cut-outs from said body to reduce the weight thereof.

9. The tool of claim 7, wherein said cut-outs comprise indicia of tool characteristics.

10. A hand-operated tool for handling a heavy plate, comprising:
a body having first and second opposed gripping members having inner edges defining a notch for insertion of a plate;
said inner edges having stepped profiles, defining a first pair of opposed gripping surfaces and a second pair of opposed gripping surfaces located between said first pair and an opening of said notch, said notch having a first width between said first pair of opposed gripping surfaces to receive a plate of a first maximum thickness, and a second width, greater than said first width, between said second pair of opposed gripping surfaces to receive a plate of a second maximum thickness, greater than said first maximum thickness;
an elongate handle extending from said body;
each of said pairs of opposed gripping surfaces operable to frictionally and releasably retain a plate in said notch, by applying a force to said handle perpendicular to a top or bottom surface of said plate.

11. The tool of claim 10, wherein said notch extends along a notch axis and said gripping surfaces are configured symmetrically about said notch axis.

12. The tool of claim 11, wherein said inner edges define eight pairs of opposed gripping surfaces, wherein the width of said notch measured between said pairs of opposed gripping surfaces tapers from a maximum of 1 9/16 inches proximate said opening of said notch, to a minimum of ½ inch, in increments of 3/16 inch.

13. The tool of claim 10, wherein said elongate handle is between about 20 inches and 44 inches in length.

14. The tool of claim 11, wherein said gripping surfaces are oriented parallel to said notch axis

15. The tool of claim 11, wherein said handle is aligned with said notch axis

16. The tool of claim 10, further comprising cut-outs from said body to reduce the weight thereof

17. The tool of claim 16, wherein said cut-outs comprise indicia of tool characteristics.
